(19) United States
(12) Patent Application Publication
(10) Pub. No.: US 2009/0035624 A1
(43) Pub. Date: Feb. 5, 2009

(54) Fuel gas generation supply equipment

(76) Inventor: Koji Kobayashi, Toyota-shi (JP)

Correspondence Address: STINSON MORRISON HECKER LLP;ATTN: PATENT GROUP, 1201 WALNUT STREET, SUITE 2800, KANSAS CITY, MO, 64106-2150, US

(21) Appl. No.: 11/729,069

(22) Filed: Mar. 28, 2007

(51) Int. Cl. H01M 8/18; B01J 19/00; G05D 16/00

(52) U.S. Cl. 429/19; 422/211; 422/112

(57) ABSTRACT

A device for generating a gas by causing a reactive fluid to come into gas producing contact with a reactive particulate material The device includes a first storage body for containing a reactive fluid and a second storage body for containing a reactive particulate material. A conduit is provided for directing a flow of reactive fluid from the first body and into the second body. A reverse flow prevention valve is connected to the conduit to prevent back flow of produced gas from the second storage body and into the first storage body. A fuel supply opening is provided on the second storage body and a fluid introduction inlet is provided on the first storage body. A fluid diffuser is located in the second storage body for diffusing fluid in said particulate material. Also included is an opening and closing valve arrangement located adjacent an outlet of the conduit and having an external operator.

### FIELD OF THE INVENTION

The present invention relates to a gas generation and supply device for small fuel cells.

### BACKGROUND OF THE INVENTION

Conventionally, hydrogen stored in a metal hydride, for example, is packed in a compressed gas cylinder for use as a means of fuel supply for small fuel cells, and when fuel gas supply is necessary, an adjustment valve is opened and a hydrogen fuel is supplied to the power generating part of the fuel cell. However, such structures are often complicated, heavy and bulky, the supply volume for the hydrogen gas is not sufficient, and the same are useful generally in the area of research prototypes. For example, in an example from Canon Inc. described in a recently published non-patent reference, 0.9 NL of hydrogen fuel was stored in a compressed gas cylinder containing 4.5 cc of metal hydride, and according to the website of FC-R&D as of September 2005, 4 NL of hydrogen fuel was stored in a 30 cc compressed gas cylinder.

Other advances in technology have been seen recently, and, for example, there has been an announcement of technology that can be expected to sufficiently exceed conventional means for the amount of hydrogen gas generated slowly and stably per unit weight where “water” comes into contact with “a specially processed aluminum alloy.” This has come to be one of the most promising means for fuel supply to small fuel cells. For example, in a Canon example according to a non-patent reference identified below, there is a disclosure of actual data regarding the production of hydrogen fuel in amounts of 2 and 5 NL as a result of a reaction of roughly 1 cc of an aqueous solution of malic acid and a borohydride (NaBH4), and roughly 1 NL resulting from the reaction of 1 cc of water and 1 cc of an aluminum alloy. Incidentally, 1 cc of hydrogen gas is an amount that can drive a 3 W machine for one hour.

There is an urgent need for applications ranging from palm types to those capable of exceeding 100-1000 W, including recyclable single-use types that are of necessity safer, less expensive and lighter in weight than conventional methods, easier to handle and capable of being recycled with these advances in technology. Related prior art references include the following: [Patent References] Published Unexamined Patent Application No. 2005-19517, Published Unexamined Patent Application No. 200-93104, Published Unexamined Patent Application No. 2004-318683, Published Unexamined Patent Application No. 2000-161509. [Non-Patent References] Nikkei Electronics, Dec. 22, 2004 “Canon Announces Fuel Cell: Storage of Hydrogen Gas in Storage Alloy” (http://techon.nikkeibp.cojp/free/article/20041215/106872/) and Nikkei Electronics Jun. 6, 2005, No. 901 “Contest for Portable Borohydride Fuel Cells,” pp. 38-39.

### DISCLOSURE OF THE INVENTION

### Problems to be Solved by the Invention

Even though the new means described above is seen as one that is promising for supplying fuel for small fuel cells, one that is promising as a practical hydrogen supply means for hydrogen fuel supply based on a chemical reaction has not yet been found.

The first problem is that of supplying the necessary amount of hydrogen gas at the time it is needed. Such processing requires a good response for “contact” and “blocking” of the “particulate material” that generates the hydrogen by a chemical reaction when the solution for the “catalyst solution” comes in contact with it.

The second problem is that of providing an effective storage and release function, since it is difficult to stop the chemical reaction instantaneously.

The third problem is that of providing gas generation and supply devices capable of being used seamlessly and which have a simple structure, are inexpensive, reduced in size and capable of being made into a single package, including devices up to a class capable of generating and supplying 2 NL of fuel with a capacity of several cc, which can be used compatibly in portable applications and are capable of being reused in connection with applications of 100-1000 W in home use and mobile models.

### SUMMARY OF THE INVENTION

To solve the foregoing problems, a first feature of the present invention involves the provision of a gas generation and supply device comprising a first storage body that houses a solution supply means (for example, a balloon) and a second storage body that houses a granular material capable of causing a hydrogen gas generating chemical reaction to occur when it is contacted by the solution, and wherein the solution and the granular material are automatically brought into contact with each other during the act of joining the two storage bodies together.

Second and third features of the invention comprise the provision of a gas production and supply device that includes a solvent diffusion means for making a uniform reaction occur, and an external solution inlet (for example, an elastically deformable member made up of a material such as a hydrogen resistant fluorine based rubber).

Fourth and sixth features of the invention comprise the provision of a gas generation and supply device having a solvent passage opening and closing valve arrangement that is formed primarily from a molded material using an external operation, and wherein the valve arrangement is provided with a spring means that uses spring force in connection with the opening and closing operation and a solution diffusion means with the same operation and effect that uses magnetic force within a simple, small space.

A fifth feature of the invention comprises the provision of a gas generation and supply device wherein a hydrogen gas storage body is linked to a granular material storage body.

A seventh feature of the invention comprises the provision of a gas generation and storage device having a small space gas supply opening and closing valve arrangement that is constituted of a material where a round tube is formed from a single thin plate.

An eighth feature of the invention comprises the provision of a gas generation and supply device which includes a member that is movable in response to the amount of the generated gas in a space across a permeable material (for example, carbon cloth) in the gas producing area, and which is provided with a hydrogen production volume adjustment means that adjusts the amount of hydrogen gas produced.

Ninth and tenth features of the invention comprise the provision of a gas generation and supply device that can be used in systems ranging from gas supply pressure adjustment devices that make possible reduction to a volume of 1-2 cc at a pressure of 0.1 MPa or less based on molded materials, to applications for home use and mobile types of 100 to more than 1000 W.

Twelfth and thirteenth features of the invention comprise the provision of a gas generation and supply device to which can be added a gas production volume adjustment means that has a larger surface for taking pressure than that following along one of the wall surfaces constituting the first, second or third storage bodies, an opening and closing means for the solution provided substantially in the center of the second storage body, a means with at least one of a movable pass-through material formed as a unit with the pressure receiving surface that passes through the second storage body, a solvent diffusion means at the periphery of the movable pass-though position and solvent leak isolation means, a generated gas supply outlet linked with the pressure receiving surface for the gas production volume adjustment means, and a large pressure receiving surface area along at least one of the walls forming the storage bodies according to the same concept.

A fourteenth feature of the invention comprises the provision of a gas generation and storage device provided with a first storage body housing a catalytic solution supply means, a second storage body housing a granular material that produces hydrogen gas when contacted by the solution, a pressure chamber for the solution provided with a linking means for the second storage body, at least one electric drive means connected to the pressure chamber, and an electric voltage control means that outputs a signal that adjusts the opening and closing cf the catalyst solution supply and the amount of the supply based on control information from a fuel cell control system.

A fifteenth feature of the invention pertains to a gas generation and supply device provided with a pressure chamber for the solution, which links the first and second storage bodies having a large pressure receiving surface along at least one of the side walls forming the first, second and third storage bodies, at least one electric drive means connected on the larger surface of pressure chamber, at least one of a narrowing means provided on the solution conducting side of the pressure chamber and a reverse flow prevention means, and a drive voltage control means.

A sixteenth feature of the invention relates to a gas generation and supply device having a structure where the storage body for at least all or part of the first storage body is transparent.

### Advantages of the Invention

In accordance with the first feature of the invention, the fuel may be supplied when necessary such that it is easily handled with an operation such as putting on the cap of a fountain pen, safely and inexpensively, inclusive of small portable fuel cells. Also, it may be applied to inexpensive single-use types.

In accordance with second and third features of the invention, supplementation, reuse and recycling of the catalytic solution may be done simply by use of a means such as an injection needle.

In accordance with the fourth and sixth features of the invention, selection of a structure that uses a spring with high reliability for the manual opening and closing of the outlet valve to control starting and stopping actions for the chemical reaction or even further reduced size and space using magnetism is possible, and a supply means for all necessary amounts of fuel is possible.

In accordance with the fifth feature of the invention, prevention of fuel waste and an instant supply are possible by changing to a simple means that eliminates the time lag for hydrogen generation caused by the starting and stopping of the chemical reaction and by linked storage of a small amount of the hydrogen gas storage material.

In accordance with the seventh feature of the invention, compaction to a gas opening and closing volume of approximately 1 cc is made possible for equipment with an approximately 100 W output or less, for example, by a small space gas supply opening and closing means that uses a round tube that is formed from a thin plate.

In accordance with the eighth feature of the invention, it is possible to control the progress of the chemical reaction by the hydrogen generation volume adjustment means that adjusts the volume of hydrogen gas generated, and it is possible to have production according to the amount of fuel consumed by the application.

In accordance with the ninth and tenth features of invention, the applications of molded materials are developed based on the concept of the sixth feature of the invention, and for example, a gas supply pressure adjustment device capable of being reduced in size to a volume of approximately 2 cc for 0.1 MPa or lower is made possible.

In accordance with the twelfth and thirteenth features of the invention, freedom of arrangement is provided by forming modules of the first, second and third storage bodies, and for example, 100-1000 W class equipment may be handled by providing a gas production volume adjustment means where the pressure adjustment precision has been increased by increasing the size of the gas receiving surface and a hydrogen gas supply volume adjustment.

In accordance with the fourteenth feature of the invention, there may be a high degree of adjustment of the opening and closing of the catalyst solution supply based on control information from the fuel cell control system by making opening and closing control of the catalyst solution supply that has an electric drive means and waste is eliminated by raising the precision of the amount of catalyst solution supplied. Furthermore, there may be compatibility with predictive control that stops the catalyst solution supply with consideration given to the amount of hydrogen storage in the metal hydride before the ending of operation according to the operating pattern.

In accordance with the fifteenth feature of the invention, a high level of control may be handled by the electric drive means that is in contact with the surface that is connected on the larger surface of pressure chamber even for the handling of, for example, 100-1000 W class equipment through the fusion and development of the concepts of the tenth and twelfth features of invention.

In accordance with the sixteenth feature of the invention, the amount of catalytic solution remaining may easily be grasped, and in addition, the phenomenon may be understood by a typical person in a form that may be seen even though it is advanced technology.

### BRIEF DESCRIPTION OF THE DRAWINGS

FIG. 1 is a cross-sectional view of a round gas cylinder hydrogen gas generation and supply device that incorporates the concepts and principles of the present invention.

FIG. 2 is a cross-sectional view similar to FIG. 1, where the device is provided with an external opening and closing valve for controlling gas generation and delivery.

FIG. 3 is a cross-sectional view similar to FIG. 2, where the device is provided with a metal hydride and gas supply opening and closing valve arrangement.

FIG. 4 is a cross-sectional view similar to FIG. 2, where the device is provided with a gas generation control valve.

FIG. 5 is a cross-sectional view similar to FIG. 4, where the device is provided with a metal hydride and gas supply pressure adjustment valve.

FIG. 6 is a cross-sectional view illustrating the structure of a simplified gas supply pressure adjustment valve for use with the device of FIG. 5.

FIG. 7 is a cross-sectional view illustrating the structure of a gas supply pressure adjustment valve for use with the device of FIG. 5 where the valve has been made to handle higher pressures.

FIG. 8 is a cross-sectional view of a parallel single body type hydrogen gas generation and supply device which embodies the concepts and principles of the present invention.

FIG. 9 is an outline view of the device of FIG. 8.

FIG. 10 is a cross-sectional view illustrating a device where gravity diffusion of the discharge liquid is employed.

FIG. 11 is a cross-sectional view where the device of FIG. 10 is provided with a gas supply pressure adjustment valve.

FIG. 12 is a cross-sectional view of the round gas cylinder type hydrogen gas generation and supply device of FIG. 2, where the device is provided with an electric drive opening and closing valve.

FIG. 13 is a cross-sectional view of the device of FIG. 12, where the device is provided with a metal hydride and gas supply opening and closing valve.

FIG. 14 is a cross-sectional view of the device of FIG. 13, where the device is provided with an electric drive opening and closing valve.

FIG. 15 is an outline view of the device of FIG. 14.

FIG. 16 is a cross-sectional view of the device of FIG. 10, where the device is provided with an electric drive opening and closing valve.

FIG. 17 is a cross-sectional view showing a regulator mechanism for a conventional fuel cell system.

### DESCRIPTION OF THE PREFERRED EMBODIMENTS

In the following description, embodiments of the present invention will be described with reference to the accompanying the drawings.

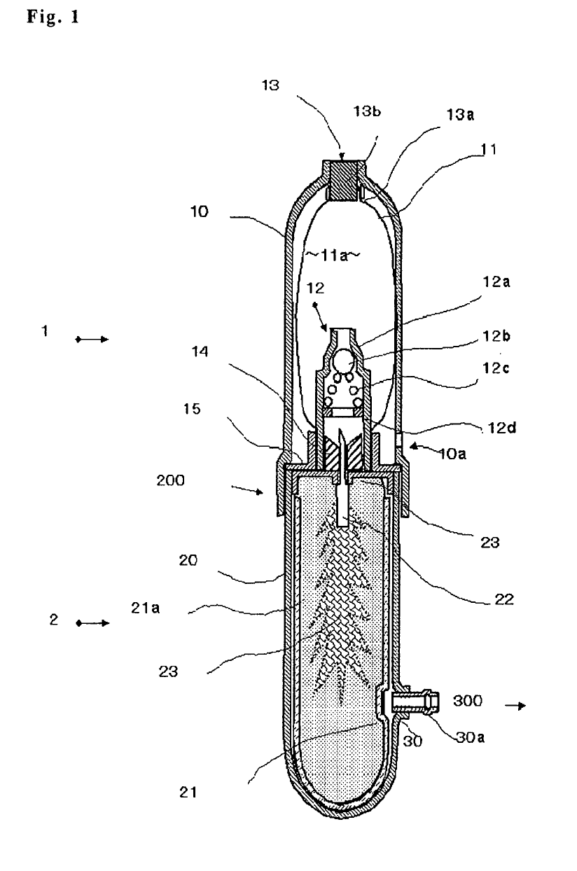

FIG. 1 is a cross-sectional view of a hydrogen gas generation and supply device wherein hydrogen gas is generated by a chemical reaction and supplied as fuel gas to a small, portable fuel cell.

The gas generation and supply device of FIG. 1 is constituted of a first storage body 1 and a second storage body 2, which bodies are shown in an integrated state and referred to as integrated part 200. Storage body 1 includes a housing 10 having an air hole 10a therein, which housing 10, may, for example, be totally transparent when used with a low pressure, small volume hydrogen gas supply at approximately 0.1 Pa. The device of FIG. 1 also includes a rubber balloon 11 that houses a catalytic solution 11a which may, for example, be water, or an aqueous solution of malic acid, or the like, a solution reverse flow prevention valve 12 comprising a tubular body 12a formed of a hydrogen resistant fluorine based material, a ball 12b, a spring 12c and a spring retainer 12d, and, for example, a plug 14 of the same material as the balloon along with a seat 15 pressed into the integrated part 200. In addition, solution 11a may be introduced into balloon 11 from the outside via an inlet 13 provided with plug 13b having the same structure as the plug 14 and a fastening ring 13a. Although balloon 11 is shown in FIG. 1, since the amount of the solution 11a consumed in the chemical reaction is small for small fuel cells, balloon 11 may not be needed because there may be a capillary effect that has the same function. Moreover, it may be possible to use positional energy or a pressurizing and reduction means as a replacement for the balloon 11.

With further reference to FIG. 1, second storage body 2 stores a particulate material 21a, (for example, specially processed aluminum alloy, borohydride (NaBH4), or the like) that generates hydrogen gas through contact with the solution 11a and a resultant chemical reaction, which reaction takes place within a gas permeable material 21 (for example, carbon cloth with good gas permeability). A needle shaped conduit 22 carried by storage body 2 is pressed through plug 14 and into body 20 by means of a seat 23 that is pressed into body 2, and in the process when bodies 1 and 2 are integrated in the integrated part 200, the needle shaped conduit 22 projects through the plug 14, and the solution 11a flows into the second storage body 2. A diffusing material 23 (for example, a foamed metal made of SUS, carbon cloth, or the like) to facilitate diffusion of the solution 11a is connected to the outlet of the conduit 22 and is positioned substantially in the center of the storage body 2 as shown. Hydrogen gas 300 produced by the resultant uniform chemical reaction is supplied evenly through a tube 30a that is pressed into a supply opening 30 provided in the body 20. From the above it can be seen that a small hydrogen gas generation and supply device according to the present invention may be in the form of a 2-3 NL fuel supply cylinder with a diameter of 10 mm or less and a length of several tens of mm.

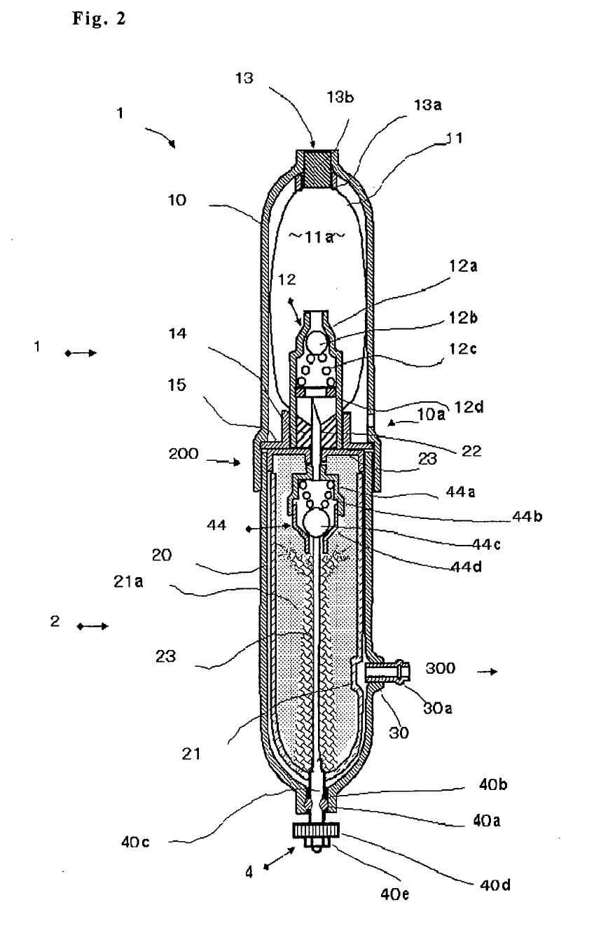

FIG. 2 is a cross-sectional view of a hydrogen gas generation and supply device that embodies a second feature of the present invention. The second storage body 2 of this device of FIG. 2 has an external opening and closing function provided by an external valve arrangement 4 that makes it possible to perform a flow opening and closing operation for the solution 11a to the second storage body 2 and an opening and closing valve 44 that is part of the valve arrangement 4 is added to the device of FIG. 1. In addition, the first storage body 1 has the same constitution as shown in FIG. 1. Therefore, the same element numbers are given to the same parts, and duplicate descriptions are omitted.

The external opening and closing valve arrangement 4 is joined to the body 20 through an O-ring 40a by a screw 40b, and the ball 44c of the opening and closing valve 44 may be opened and closed by an external screw knob 40d. The opening and closing valve 44 is pressed toward the conduit 22, and bodies 44a and 44d, which are provided with a spring 44b and a ball 44c, are pressed toward each other. The ball 44c is pressed in the direction of release by a shaft 40c through the turning of the screw knob 40d, which is screwed into a nut 40e, and the solution 11a may then flow into the second storage body 2 through the gap between ball 14c and body 44b. If the screw 40d is turned in the opposite direction, the ball 44c moves in the closing direction. A solution diffusing material 23 is provided on the periphery of the shaft 40c.

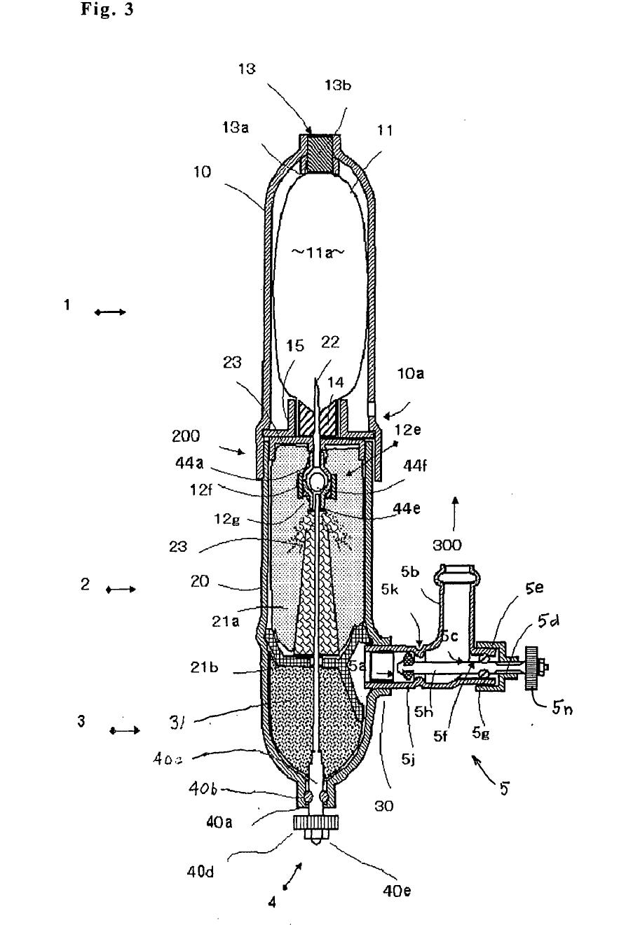

FIG. 3 is a cross-sectional view of a hydrogen gas generation and supply device comprising a third feature of the present invention. In the device of FIG. 3, the reverse flow prevention valve 12 of the device of FIG. 2 is replaced by a reverse flow prevention valve 12e and a magnet 12g, and a third storage body 3 and a generated gas supply opening and closing valve 5 are added to the second storage body 2. Therefore, the same element numbers are given to the same parts, and duplicate descriptions are omitted.

When ball 44f is affected by magnetism and the body 44e is not magnetic, the opening and closing valve 12e is joined with the magnet 12g and the needle shaped conduit 22 by pressing using a round tube 12f. Ball 44f is pulled by magnet 12g to a closed position that prevents the flow of the solution 11a into body 2. The shaft 40c may then be pushed up to a position to dislodge ball 44f and permit solution 11a to flow into body 2 by manual operation of the opening and closing knob 40d. However, the magnitude of the magnetic force exerted by magnet 12g is set so that valve 44 is closed whenever generated gas attempts to flow backwardly into first storage body 1.

With reference again to FIG. 3, a metal hydride material 31 is segregated from the particulate material 21a by a separation element 21b formed from a gas permeable material. Accordingly, the metal hydride material 31 may store and release hydrogen gas located in body 20. When the opening and closing valve 12e is open, hydrogen gas is released instantly by the metal hydride material 31, and the delay in the gas generation rate during the initial phases of the chemical reaction is thusly supplemented. A generated gas supply opening and closing valve arrangement 5 is provided at the generated gas supply opening 30. Arrangement 5 includes a generally T-shaped tubular valve body 5b made up of a first tubular portion presenting an opening and closing operation opening 5c, a second tubular portion presenting a generated gas inflow opening 5a, and a third tubular portion presenting an outflow opening 300. Body 5b may be formed from a single, thin cast plate round tube (for example, employing an aluminum tube forming process). Valve arrangement 5 may also include a cap 5e for closing opening 5c, and which is formed from a thin, cast plate round tube provided with female screw threads 5d pressed into the interior surface of cap 5e, a flat surface 5f provided on the interior surface of operation opening 5c, an O-ring 5g which cooperates with flat surface 5f to provide a gas isolation seal, and male screw threads 5i are disposed on the outer surface of a shaft 5h in a position for meshing with female screw threads 5d. Arrangement 5 further may include a pinched part 5k located in a position on the second tubular portion that presents generated gas inflow opening 5a. Pinched part 5k cooperates with a seat 5j on shaft 5h to open and close opening 5a. To this end, seat 5j is elastic and deforming, and the same is screwed toward and away from pinched part 5k by means of a knob 5n, and for equipment with an approximately 100 W output or lower, for example, valve arrangement 5 may be made compact with a volume of approximately 1 cc or less for the entire supply opening and closing function.

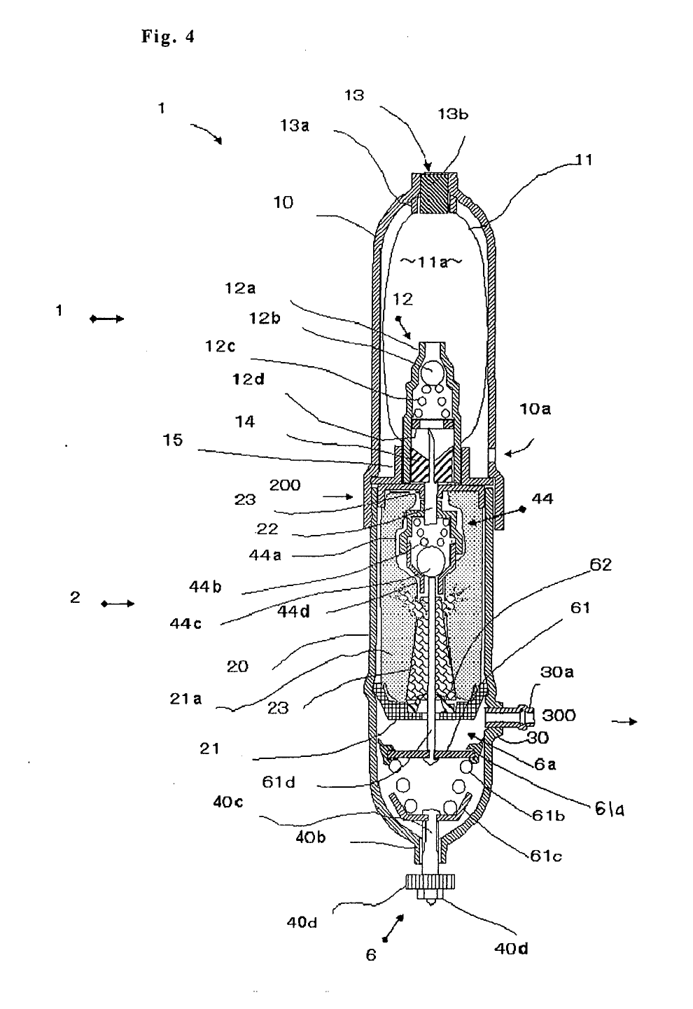

FIG. 4 is a cross-sectional view of a hydrogen gas generation and supply device comprising a fourth feature of the present invention. The second storage body 2 of the device of FIG. 4 includes a hydrogen gas generation volume adjustment valve arrangement 6 added to the device of FIG. 2. Therefore, the same element numbers are given to the same parts, and duplicate descriptions are omitted.

The hydrogen gas volume adjustment valve arrangement 6 of the device of FIG. 4 is provided with a sealing element 61a disposed in a space 6a which is adjacent to particulate material 21a but is segregated therefrom by gas permeable material 21. A shaft 61d, which penetrates through body 2, contacts ball 44c and is secured to and is in contact with a thin plate die cast movable member 61 that is held in place by the sealing element 61a. The member 61 then deforms depending on how high or low the generated gas pressure is in space 6a. A seat 61c secured to a stub shaft 40c provides a seat for a spring 61b on the back-pressure side of member 61. When the pressure in space 6a above movable member 61 is higher than a prescribed pressure, the force applied to member 61 by spring 61b is overcome and the member 61 moves downwardly to allow the ball 44c to move in the closing direction, and when the pressure in space 6a is lower than the prescribed pressure, the spring 61b will operate to overcome the pressure so as to move member 61 and thereby ball 44c upwardly in the opening direction, whereby the amount of generated gas may be adjusted. A diffusing material 23 and an elastic seal material capable of preventing entry of solution 11a are provided around shaft 61d.

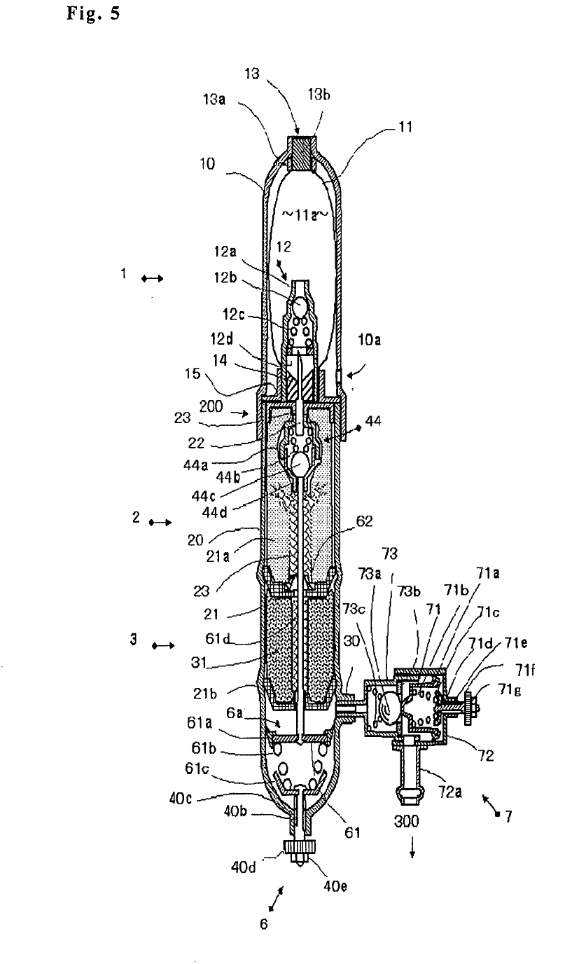

FIG. 5 is a cross-sectional view of a hydrogen gas generation and supply device comprising a fifth feature of the present invention. This device of FIG. 5 is one where a third storage chamber 3 and a new hydrogen gas supply pressure adjustment valve arrangement 7 are added to the second storage body 2. Therefore, the same element numbers are given to the same parts, and duplicate descriptions are omitted.

The hydrogen gas supply pressure adjustment valve arrangement 7 of FIG. 5 is connected to a thin plate die cast movable member 71 provided with a seal 71a on the outer periphery thereof and the same presents a convex shape relative to the side receiving the pressure of the generated gas. Arrangement 7 also includes a seat 71c where a spring 71b is seated in the concave interior of member 71. Seat 71c is secured to a stub shaft 71d by screws 71f, 71g. An opening and closing ball 73a is operated on by shaft 71d working spring 71b which pushes member 71 toward ball 73a. For this purpose complimentary screw threads provided on shaft 71d cooperate with screw threads 71e in body 72. Ball 73a is housed in body 73 along with plate 73b and spring 73c. A unitary body is thus formed by pressing the body 72 into place around body 73 as shown in FIG. 5. A gas supply opening 30 is pressed onto a stub pipe extending from body 73 as shown. A discharge tube 72a is connected to body 72 as shown. Therefore, for example, it is possible to have a gas supply adjustment device using a thin plate die casting (made, for example, using an aluminum tube die casting process) that may be made small to the extent of handling a volume of 1-2 cc at a supply pressure of 0.1 MPa.

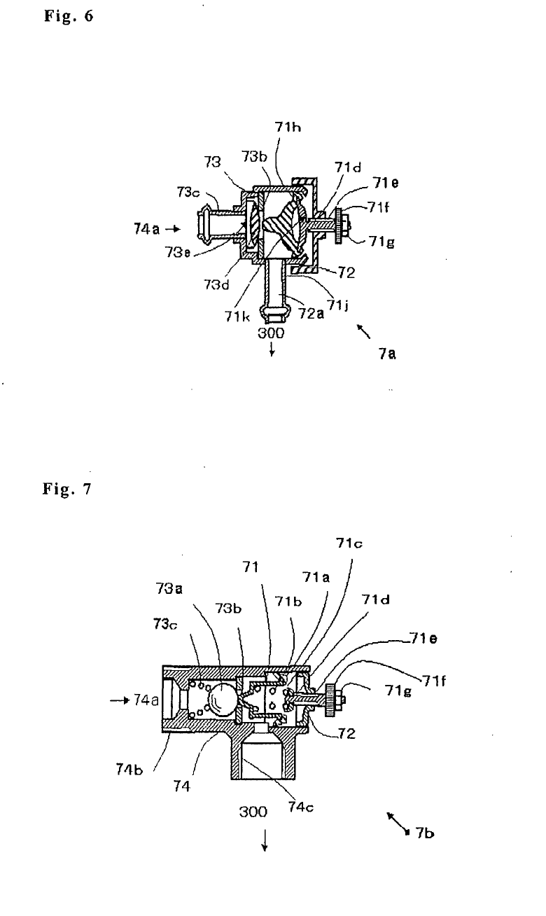

FIG. 6 is a cross-sectional view of an alternative valve arrangement 7a which may be used instead of the valve arrangement 7. Arrangement 7a is made of the die cast material described above in connection with the device of FIG. 5, and the same is designed so as to reduce the space requirements and expense of the device, to thereby facilitate the production of small, portable, disposable devices useful for applications with power requirements of the several tens of watts class, for example. Basically, the constitution and operation are the same as with the device of FIG. 5 described above, so the same element numbers are applied to parts with common functions, and duplicate descriptions are omitted.

As shown in FIG. 6, only elastic deforming members 71h and 73d are housed in the body 73 of valve arrangement 7a. The member 71h, having a concave outer surface, is joined to the crescent shaped outer periphery of the shaft 71d, to present a cavity 71k therebetween for increasing the freedom of selection for the load characteristics of the shaft 71d in the movable direction. The outer periphery of discharge tube 72a is provided with a shape 71j which is in contact with the body 73 to prevent gas from leaking. The deforming member 73d has a semicircular shape, and the gas inflow side 74a is provided with at least one slit 73e where gas flows. In a state where the seat 73b is in contact with member 73d, the latter has a prescribed amount of elastic deformation, whereby the seat 73b and the member 73d are in a gas sealing state. The operating principles for the valve arrangement 7a of FIG. 6 are the same as those described above in connection with the valve arrangement 7 of FIG. 5.

FIG. 7 is a cross-sectional view of a further alternative valve arrangement 7b which may be used instead of the valve arrangements 7 and 7a. Arrangement 7b facilitates the use of a highly precise high pressure supply of fuel for power requirements in the 100-1000 W class, for example, and which is the reverse of valve arrangement 7a. Basically, the constitution and operation of arrangement 7b are the same as for arrangements 7 and 7a, so the same element numbers are applied to parts with common functions, and duplicate descriptions are omitted.

In FIG. 7, the parts housed in the bodies 72 and 74 disclosed for the hydrogen gas generation and supply valve arrangement 7 may be housed in a single body (for example, a cast aluminum product) that has been machine processed in only one direction, and a highly precise high supply pressure device for use where the power requirements are in the 100-1000 W class is made possible. Joining screw threads 74b on the outside periphery of the hydrogen gas inlet and joining screw-threads 74c on the inside periphery of the flow outlet 300 are provided in this device as is illustrated in FIG. 7.

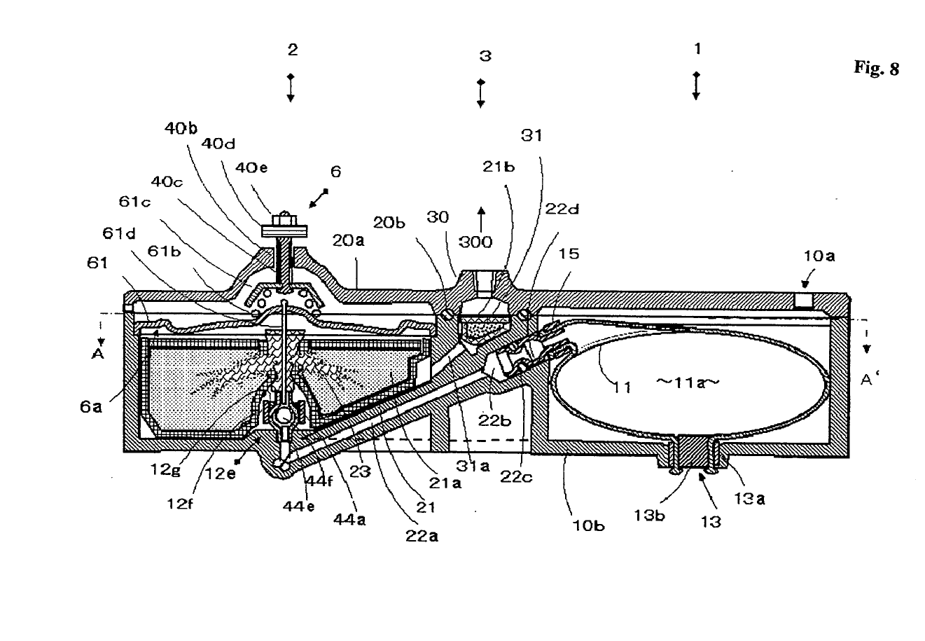

FIG. 8 is a cross-sectional view of a hydrogen gas generation and supply device comprising an eighth feature of the present invention. This device shown in FIG. 8 has the same constituency and functions as the device illustrated in FIG. 5, except that the first storage body 1, second storage body 2 and third storage body 3 are disposed and arranged in parallel. Through the use of the unitary body construction illustrated in FIG. 8, fuel supply control and pressure adjustment precision are provided so as to make various applications in the 100-1000 W class possible while still allowing for compactness. Therefore, the same element numbers are given to the same parts, and duplicate descriptions are omitted.

The third storage body 3 of the device of FIG. 8 uses excess space in the storage bodies 1 and 2, and all three bodies are housed in a single structure 10b having parallel spaces that may be die cast as a single unit with die cast aluminum for example. The first and second storage bodies 1 and 2 are interconnected via a through hole 22a provided with a joining opening 22b that the solution 11a passes through during operation, and a tube 22d provided with an O-ring 22c is inserted into the opening 22b. In addition, the third storage body 3 is provided with a seal 20b between a through hole 31a and a cover 20a. A diaphragm 61 provided with a wide pressure receiving surface area is pressed into the body 10b along the upper surface of the second storage body 2, as shown, to raise the adjustment precision. A shaft 61d, that passes through the storage body 2, is secured to the diaphragm 61, and a hydrogen gas opening and closing valve 12e is provided with a magnet 12g similarly to the arrangement of FIG. 3. Therefore, a structure that supplies the generated hydrogen gas with increased pressure adjustment precision from the outlet 300 is possible with one body 10b and one cover 20b.

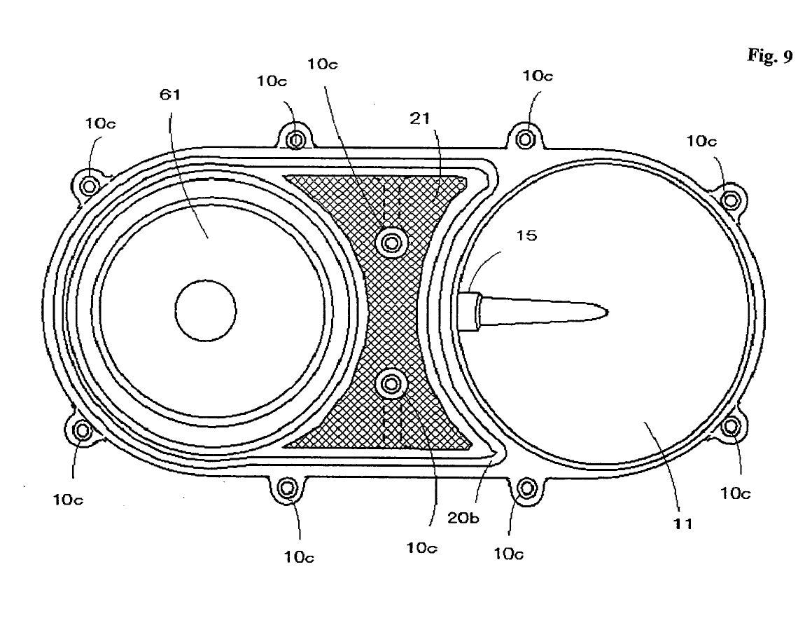

FIG. 9 is a drawing showing a cross-sectional view of the device of FIG. 8 taken along the line A-A′ of FIG. 8, and the element numbers are the same as in FIG. 8. A bolt hole 10c for attaching the cover 20a to body 10b can be seen in FIG. 9.

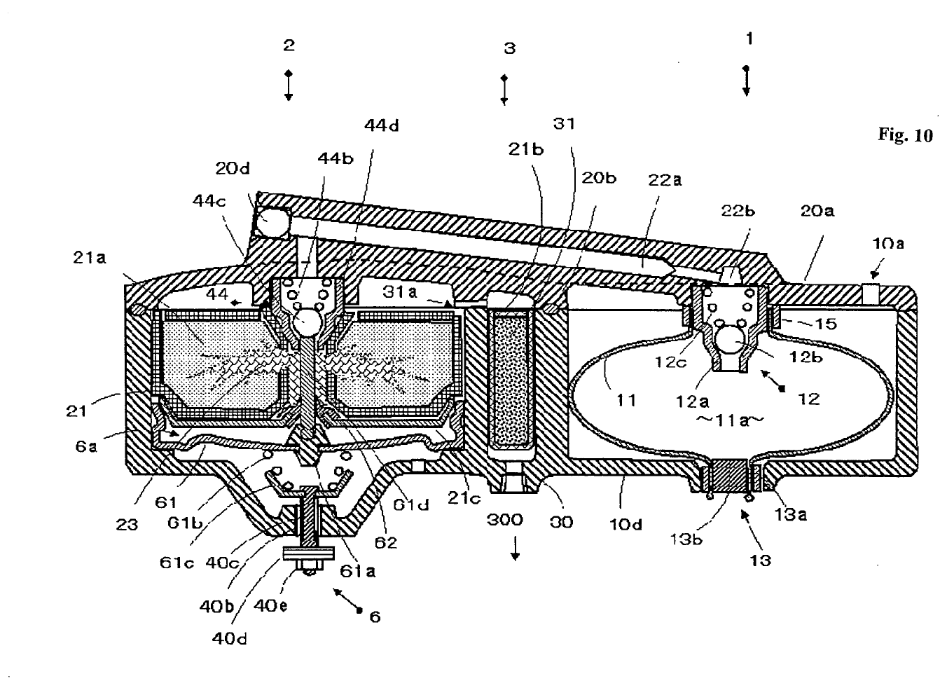

FIG. 10 is a cross-sectional view of a hydrogen gas generation and supply device that comprises a tenth feature of the present invention. The first, second and third storage bodies 1, 2 and 3 of the device of FIG. 10 basically have the same constituents as the device of FIG. 8, but the constitution is such that the function of the opening and closing valve 12e provided with the magnet 12g is performed using a reverse flow prevention valve 12 and the solution opening and closing valve 44 located in the first storage body 1. The device of FIG. 10 has a structure where the solution 11a also may use gravity to drip down into storage body 2 for the purpose of further increasing the reliability of the operation of the device. Therefore, the same element numbers are given to the same parts, and duplicate descriptions are omitted.

In the device of FIG. 10, a reverse flow prevention valve 12 for the first storage body 1, which performs the first function that was provided by the opening and closing valve 12e and the magnet 12g of FIG. 8, is provided on the balloon 11 side of the through hole 22a for the storage bodies 1 and 2. The solution opening and closing valve 44, which performs the second function that was provided by the opening and closing valve 12e and the magnet 12g of FIG. 8, is provided on the upper part of the second storage body 2, so that it can make use of gravity. The hydrogen gas generated amount adjustment valve assembly 6 is disposed at the bottom part of the body 2. A variable space 6a is provided between diaphragm 61, that has a large surface area, and a gas permeable plate 21 (formed from a foamed metal made of SUS, for example). The shaft 61d is given flexibility through the use of a rubber grommet 61a, and a seal 62 is provided to prevent leaking of the solution 11a. Accordingly, the device of FIG. 10 is a gas generation and supply device characterized by increased reliability as described above.

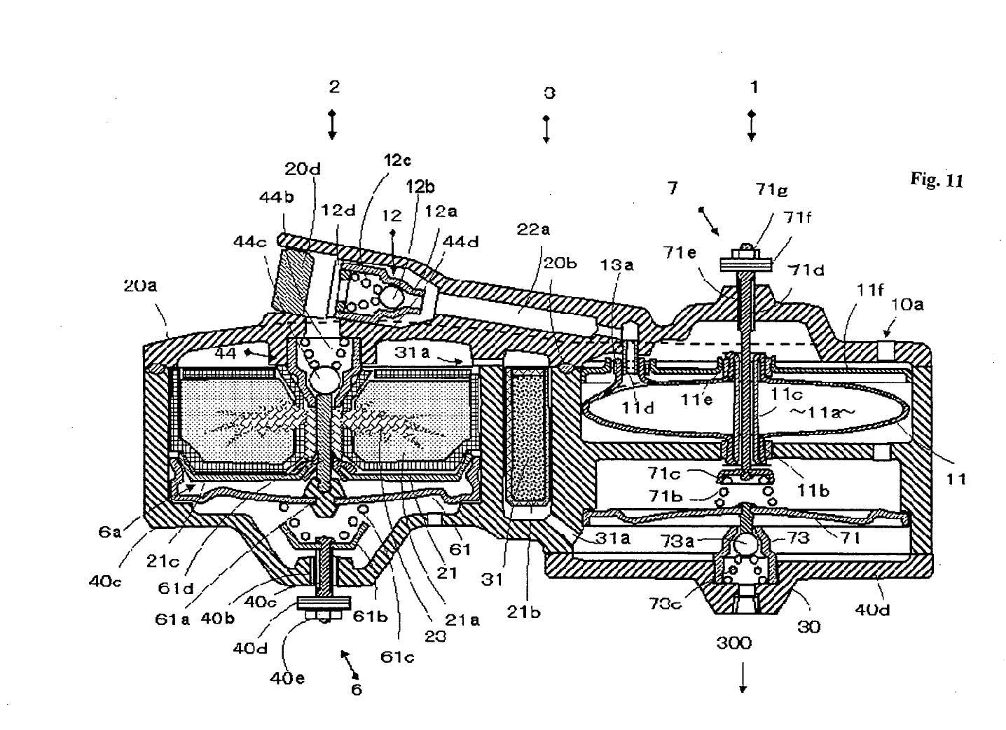

FIG. 11 is a cross-sectional view of a hydrogen gas generation and supply device comprised of an eleventh feature of the present invention. This eleventh feature is one where a hydrogen gas supply adjustment function is added to the first storage body 1 of the device of FIG. 10. Therefore, the same element numbers are given to the same parts, and duplicate descriptions are omitted.

The hydrogen gas supply adjustment function of the device of FIG. 11 is provided by a valve arrangement 7 having a diaphragm 71 that has a large pressure receiving surface area disposed along the lower surface of the first storage body 1, and this diaphragm 71 receives pressure through the through holes 31a located between the first and second storage bodies 1 and 2. Diaphragm 71 operates in conjunction with the opening and closing ball 73a to supply and adjust the pressure of the fuel gas flowing to the supply opening 300 in the cover 40d. The shaft 71d, which is a unit with an external screw knob 71f, passes through the first storage body 1 on the back pressure side of the diaphragm 71, and the spring 71b operates to add and reduce pressure on the external screw knob 71f via the shaft 71c. The shaft 71d can move in a hollow tube 11c sealed from the balloon 11 by rings 11b and 11e, and the solution 11a is introduced into the cover 20a by way of a pipe lid secured by a plate 11f. The device of FIG. 11 is thus an inexpensive, compact gas generation and supply device having a single body and two covers, but having a high level of supply pressure precision, that is further characterized by being useful, for example, in the 100-1000 W class.

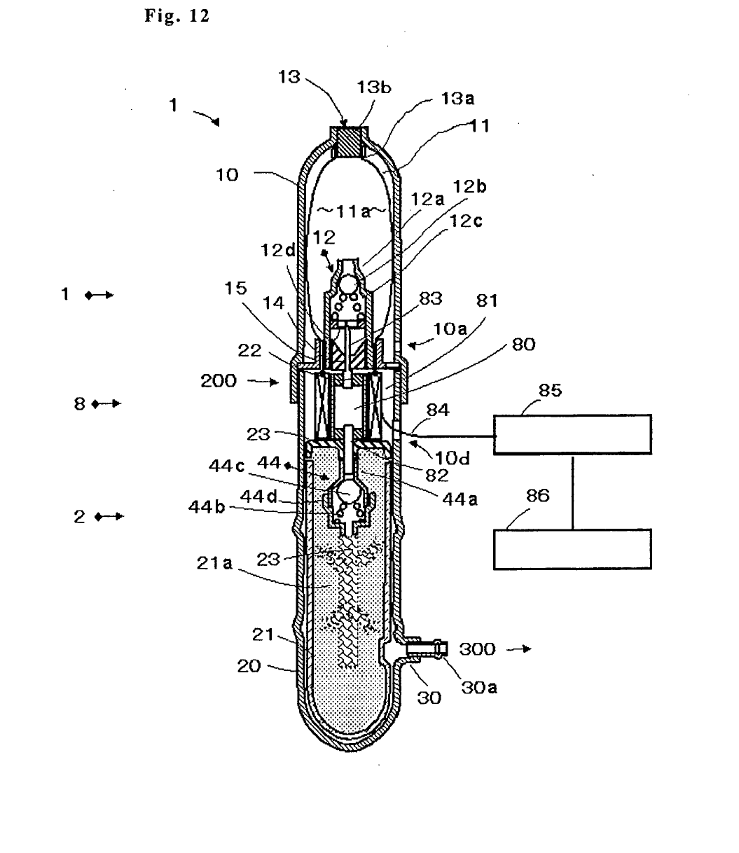

FIG. 12 is a cross-sectional view of a hydrogen gas generation and supply device comprising a twelfth feature of the present invention. As is shown in FIG. 12, the device uses an electric drive for operating the opening and closing valve assembly 44, which is similar to the valve assembly 44 of the device of FIG. 2, as described above, and the same comprises a hydrogen gas generation and supply pressure adjustment device capable of higher level control for a fuel cell system. Therefore, the same element numbers are given to the same parts, and duplicate descriptions are omitted.

The electric drive for opening and closing the valve assembly 44 of FIG. 12 is identified by the reference numeral 8, and the same includes an actuator 81 located within a single pressure chamber 80 linking the first and second storage bodies 1 and 2. A body 44a that has a restriction 83 on the solution conduit side 22, and a reverse flow prevention valve arrangement 44 on the discharge side 82 is pressed into body 2 and sealed. As mentioned above, actuator 81, which may be a piezo actuator, for example, is located within pressure chamber 80, and an opening and closing control signal is received based on control information from a fuel cell control system 86 from a circuit 84. Wasteful consumption of the solution is prevented by providing a drive voltage control device 85 for the output, and it is possible to have high level control capable of determining the timing for stopping the catalytic solution supply with consideration given to the amount of stored hydrogen in the metal hydride before ending operation according to the operating pattern using predictive control.

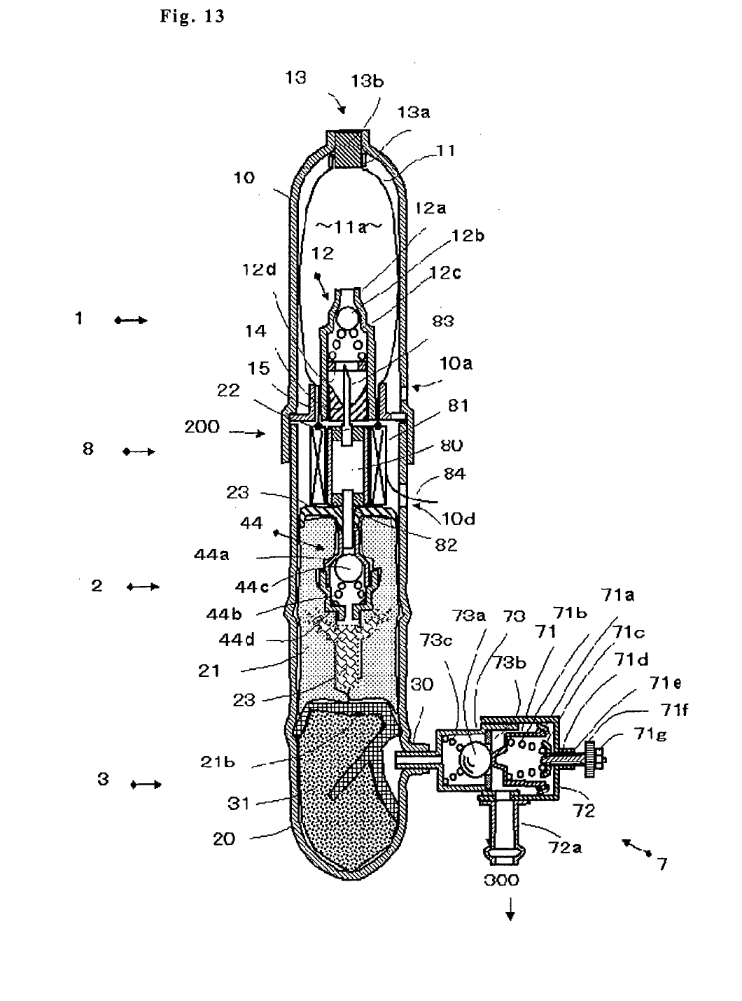

FIG. 13 is a cross-sectional view of a hydrogen gas generation and supply device comprising a thirteenth feature of the present invention. This thirteenth feature is one that adds a third storage body 3 and a valve assembly 7 providing a hydrogen supply pressure adjustment function to the device of FIG. 12. Therefore, the same element numbers are given to the same parts, and duplicate descriptions are omitted.

The third storage body 3 is adjacent to the second storage body 2, and the bodies 2 and 3 are separated by a gas permeable material 21b, and a hydrogen gas supply pressure adjustment valve assembly 7 is provided on the outlet 30. Since a description of these components has already been given, it will be omitted, but suffice it to say, the device of FIG. 13 provides a hydrogen gas generation and supply pressure adjustment device suitable for use in connection with 100 W or lower class equipment, for example, and further includes an electric drive device in a small highly functional, portable gas cylinder shape.

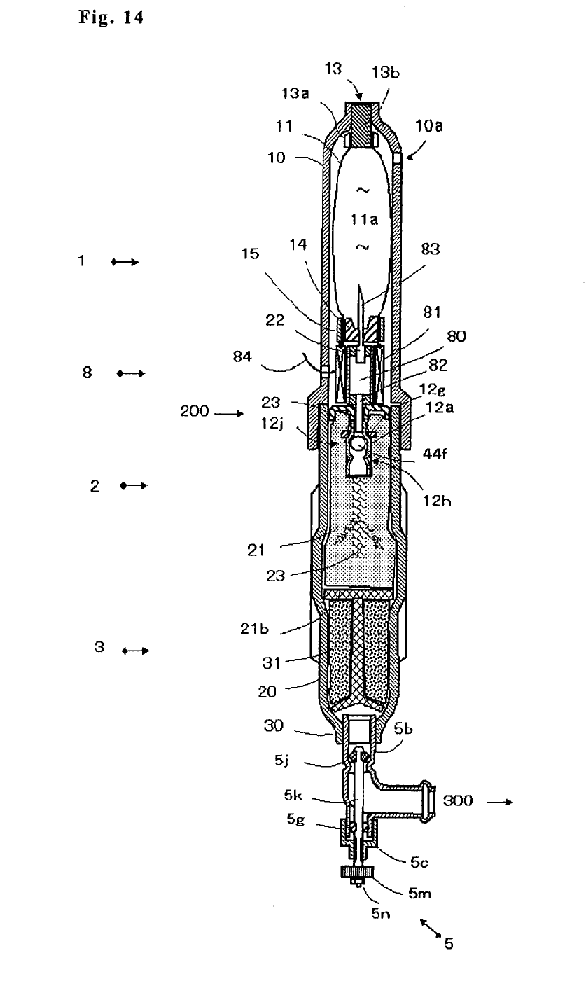

FIG. 14 is a cross-sectional view of a hydrogen gas generation and supply device comprised of a fourteenth feature of the present invention. This device of FIG. 14 has a structure that is based on the device of FIG. 13, which is provided with the reverse flow prevention valve 12f that makes use of the magnet shown in FIG. 8 and the opening and closing function provided by the valve assembly 5 of FIG. 3, and the same is capable of being used in connection with thin card type applications. Therefore, the same element numbers are given to the same parts, and duplicate descriptions are omitted.

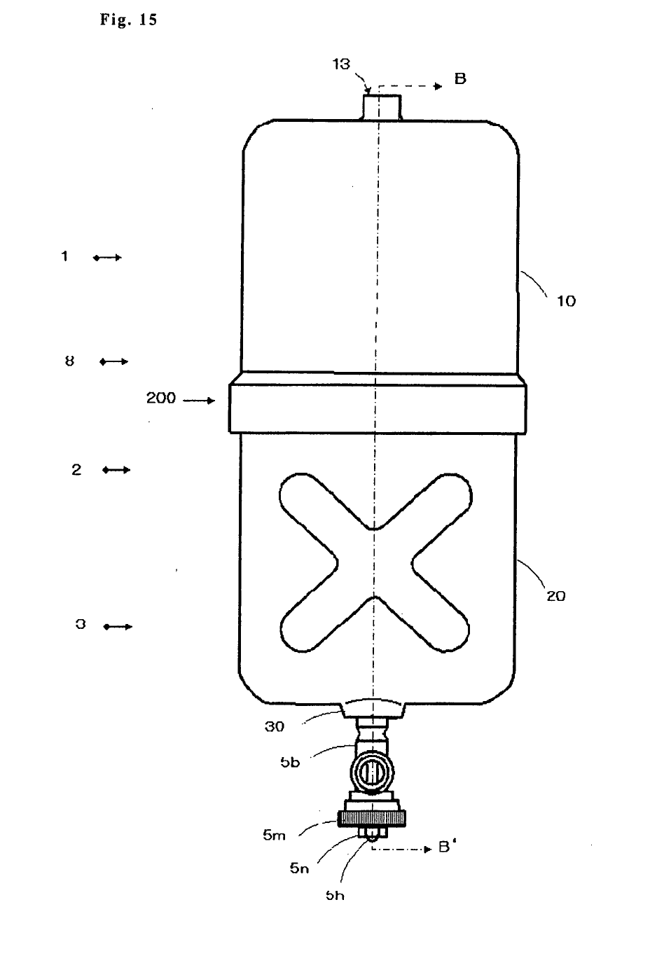

The reverse flow prevention valve 12f was described above in connection with the FIG. 3, and is such that the opening and closing valve 12e and the magnet 12g are made so as to be compatible with the electric drive device 81. The magnet 12g is provided on the first storage body 1 side of the body 12a, and the position of the ball 44f in the closed state is at the top of the body 12a. The force of the magnet 12g is higher than the pressure in the balloon 11 and lower than the discharge force for the solution 11 from the pressure chamber 80 using the electric drive. The ball 44f pressed by the discharge force is held in place by at least one protrusion 12h provided on the body 12a, and the solution 11a may flow out into the second storage body 2 through a gap presented between ball 44f and an inner wall of body 12a. In addition, as is shown in FIG. 15, applications that this fourteenth feature is compatible with may be provided with an electric drive means 81 having a surface that is wider than the round gas cylinder type of devices shown in FIGS. 12 and 13. Since the discharge amount and pressure have high capacities, it is sufficiently possible to have a setting lower than the gas pressure, and use in connection with thin card type applications is therefore possible. In addition, an example where the opening and closing device 5 is pressed into the supply opening 30 is shown.

FIG. 15 is an outline view of the device of FIG. 14, and the same parts are given the same element numbers. In this regard it is to be noted that FIG. 14 is a cross-sectional view of the device taken along the line B-B′ of FIG. 15.

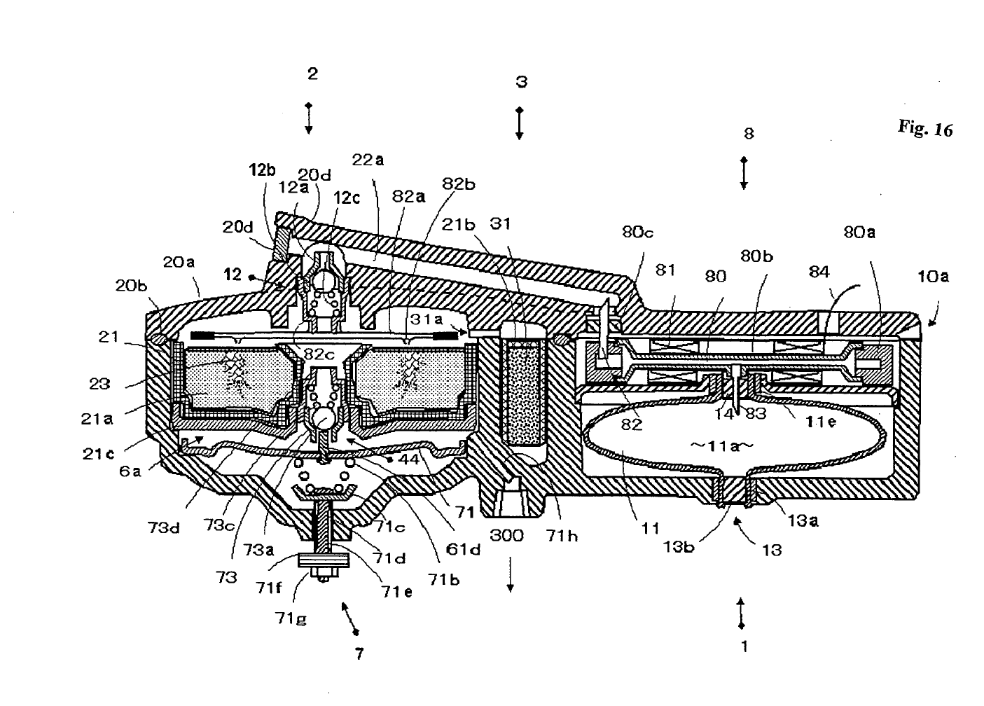

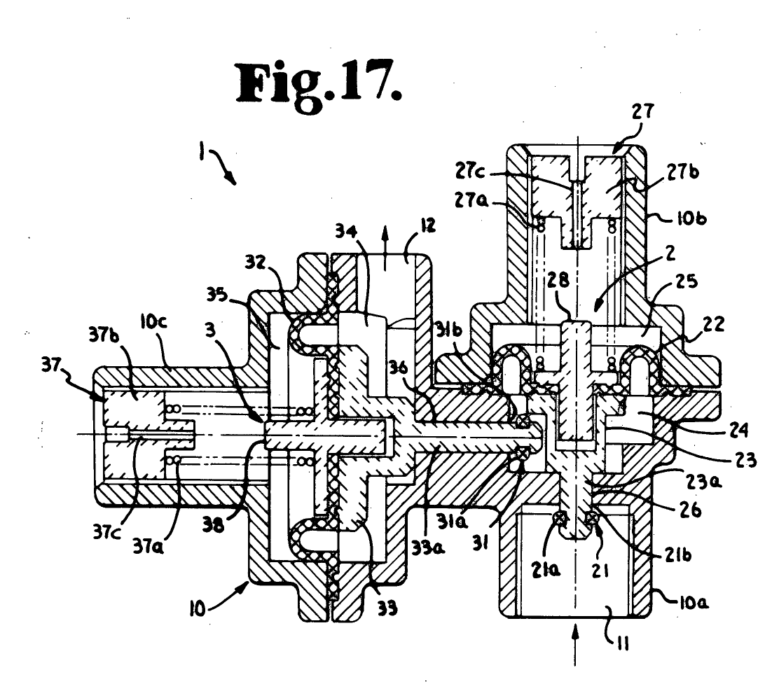

FIG. 16 is a cross-sectional view of a hydrogen gas generation and supply device comprising a sixteenth feature of the present invention. This sixteenth feature provides an electric drive opening and closing function for the device of FIG. 14, and is a hydrogen gas generation and supply pressure adjustment device characterized by fuel supply to a fuel cell for 100-1000 W class equipment, for example, which requires a high level of control for the device of FIG. 14. Therefore, the same element numbers are given to the same parts, and duplicate descriptions are omitted.

The electric drive opening and closing function is provided by an arrangement constituted of a plate 80b into which conducting pipes 82 and 83 for the pressure chamber 80, which has a larger surface than that along the balloon 11, are pressed, and a ring 80a. The pipe 82 passes through a plug 80c, and conducts liquid to the through hole 22a. At least one ring shaped electric drive device 81, that follows the pressure chamber surface, is provided, and this increases the amount of the solution 11a discharged, and thus the discharge pressure. Therefore, a circular shaped flat member provided with at least one or more pores 82b is positioned in a flat tank 82a into which a solution nozzle to the second storage body is pressed, and a uniform jet of the solution 11a is thus made possible.

FIG. 17 is a fuel cell system regulator, and it has a back pressure chamber side diaphragm and a pressure adjustment chamber diaphragm. In an application where the pressure of the pressure adjustment chamber is adjusted by the back pressure in the back pressure chamber, the regulator of FIG. 17 is characterized by being able to adjust the pressure in a range higher than the back pressure in the back pressure chamber. Accordingly, FIG. 17 has an object different from the present invention, and even though it is not always cited as a conventional technology, it is one of those cited in constitutions of current fuel cell systems. As was described at the beginning, one of the representative conventional technologies for handling the problems faced by the present invention is a small 4 NL gas cylinder having a volume of approximately 30 cc, but a device that can be portable and generate and supply fuel and that is inexpensive, lightweight and oriented to mass production has not previously been found, so this has been cited as on example of the constitution of a current fuel cell system.

### Effects of the Features of the Invention

According to the features of the invention described above, along with developing the technology for fuel gas production, the elements of the invention are modularized so as to make the seamless handling of multiple applications possible for fuel supplies to fuel cells in equipment that has an output, for example, from approximately 3 W to over 1000 W in a new form. An invention with a large variety of forms for which the optimal variation is selectable is shown. It is of a directly implementable level, and it is one that pioneers a new supply form. Furthermore, all of the embodiments shown here may be easily developed for a variety of applications.

### Other Features of the Invention

In the embodiments of FIGS. 1 through 16, the basic functions provided with various elements are modularized for fuel supply systems for various applications, and the basic mode for each invention is shown each of those elements. It is such that combinations and applications of these embodiments may be easily made. In addition, the present invention mainly has symmetry for hydrogen fuel for fuel cells, but there are naturally many other possible applications in gases and liquids other than hydrogen for the various elements of the invention enumerated here.

### Explanation of the Elements

In the drawings, reference numerals 1, 2, 3 are storage bodies; numerals 4, 5, 6 are pressure adjustment valves; numeral 5 is an opening and closing valve; numerals 5e, 20a, 40d are covers; numerals 5g, 5j, 20b, 40b, 62 are sealing material; numeral 8 is an electric drive device; numerals 10, 12, 20, 44a, 44d, 72, 73, 73d, 74, 82c are bodies; numeral 11 is a balloon; numeral 11a is a catalytic solution; numerals 12, 44 are reverse flow prevention valves; numerals 12b, 44c, 44f, 73a are balls; numerals 12c, 44b, 61b, 71c are springs; numeral 12g is a magnet; numeral 13 is an inlet; numerals 13b, 14, 80c are rubber plugs; numeral 21 is a gas permeable material; numeral 21a is a particulate aluminum alloy; numerals 22, 82, 83 are linking pipes; numerals 22a, 31a, 71h are through holes; numeral 23 is a diffusing material; numeral 31 is a metal hydride; numerals 61, 71 are diaphragms; numerals 62, 200 are joined parts; numeral 80 is a pressure chamber; numeral 82b is a pore; numeral 85 is a drive voltage control part; numeral 86 is a fuel cell control part; and numeral 300 is a fuel supply opening.

1-16. (canceled)

17. A device for generating a gas by causing a reactive fluid to come into gas producing contact with a reactive particulate material, said device comprising:
a first storage body adapted for containing a reactive fluid;
a second storage body adapted for containing a reactive particulate material, said first and second storage bodies including respective complementary linking structures facilitating joinder of the bodies to present a single unitary structure, said linking structure including a conduit located and arranged to direct a flow of said fluid into the second body when the bodies are joined together;
a reverse flow prevention valve arrangement operably connected to said conduit, said valve arrangement being adapted to prevent back flow of produced gas from the second storage body into said first storage body; and
a fuel supply opening provided on said second storage body.

18. A gas generating device as set forth in claim 17, and a fluid diffusor located in said second storage body for diffusing said fluid in said particulate material.

19. A gas generating device as set forth in claim 17, and a fluid introduction inlet on said first storage body.

20. A gas generating device as set forth in claim 17, and an opening and closing valve arrangement located adjacent an outlet of said conduit, said arrangement including an external operator for operating said arrangement and a moveable operating member extending through said second storage body, said device further including at least one of a fluid diffuser and a fluid leak isolator mounted adjacent the moveable operating member.

21. A gas generating device as set forth in claim 17, and a third storage chamber adapted and arranged to house a gas occlusion material linked with a hydrogen generating material.

22. A gas generating device as set forth in claim 17, wherein said valve arrangement includes a ball element and a magnetic element which urges said ball element toward a predetermined position, said arrangement further including an external operator.

23. A gas generating device as set forth in claim 20, and a gas permeable member disposed in said second storage body between said particulate material and said fuel supply opening, said gas permeable member being adapted and arranged so as to define a space on an opposite side thereof from the particulate material, said device further including an element that is movable within said second storage body in response to the amount of gas present in said space, and a hydrogen sensor arrangement to control the pressure in the space by movement of the movable member.

24. A gas generating device as set forth in claim 17, and a thin plate die cast movable member provided with a concave shape on the side receiving the pressure of the gas that is produced, an elastic deforming material that is housed inside the concavity of said movable material and controls the gas supply pressure, and a gas supply pressure adjustment device from a thin plate form capable of being reduced in size to a volume of the 1-2 cc for 1 MPa or lower.

25. A gas generating device as set forth in claim 17, and an electric operator for said valve arrangement.

26. A gas generating device as set forth in claim 21, and an electric operator for said valve arrangement.

27. A device for generating a gas by causing a reactive fluid to come into gas producing contact with a reactive particulate material, said device comprising:
an elongated structure having a major axis, said structure being arranged so as to present first and second chambers therein that are spaced apart longitudinally of said major axis, said first chamber being adapted for containing and dispensing said reactive fluid, said second chamber being adapted for containing said reactive particulate material;
a through hole linking said first and second chambers so as to permit fluid flow from said first chamber and into said second chamber whereby to cause the reactive fluid to come into contact with the reactive particulate material;
a valve arrangement operably associated with said through hole for opening and closing the latter, said arrangement including a reverse flow prevention valve operably connected to said through hole preventing fluid flow from the second chamber to the first chamber,
said second chamber being positioned and arranged to cause gas to flow therethrough in a direction that is transverse to said major axis;
a gas production volume adjustment valve arrangement mounted in a space linked in fluid communication with said second chamber, said volume adjustment valve arrangement including a pressure receiving surface extending longitudinally of said major axis, said surface having a larger area than the cross-sectional area of the second chamber in a direction that is normal to said major axis; and
an external operator operably connected to said pressure receiving surface for adjusting the position of the latter.

28. A device for generating a gas as set forth in claim 27, and an electric operator for said valve arrangement.

29. A device for generating a gas as set forth in claim 25, and a drive voltage control means that outputs a signal to control the opening and closing of said valve arrangement and the supply amount of the fluid based on control information from a fuel cell control system.

30. A device for generating a gas as set forth in claim 26, and a dive voltage control means that outputs a signal to control the opening and closing of said valve arrangement and the supply amount of the fluid based on control information from a fuel cell control system.

31. A gas generating device as set forth in claim 17, wherein at least a part of one of said storage bodies is transparent.
